(19) United States
(12) Patent Application Publication
(10) Pub. No.: US 2025/0377028 A1
(43) Pub. Date: Dec. 11, 2025

(54) ELECTROMECHANICAL BRAKE

(71) Applicant: Robert Bosch GmbH, Stuttgart (DE)

(72) Inventors: Andrej Gardt, Abstatt (DE); Bernd Lutz, Kempten (DE); Dietmar Kratzer, Hersbruck (DE); Mark Boehm, Lehrensteinsfeld (DE); Martin Winkler, Sonthofen (DE)

(21) Appl. No.: 19/185,554

(22) Filed: Apr. 22, 2025

(30) Foreign Application Priority Data
Apr. 30, 2024 (DE) 10 2024 204 065.7

(51) Int. Cl. F16D 65/18; F16D 55/00; F16D 121/24; F16D 125/40

(52) U.S. Cl. CPC F16D 65/18; F16D 2055/0033; F16D 2121/24; F16D 2125/40; F16D 2250/0076

(57) ABSTRACT

An electromechanical brake for a motor vehicle. The electromechanical brake includes an electric motor which drives a spindle drive unit via a transmission unit, via which spindle drive unit a brake actuator is axially movable for braking. A drive housing which accommodates at least the transmission unit and the spindle drive unit is provided. The drive housing is provided as a separate part to a brake clamp encompassing a brake disc and is connected to the brake clamp. The drive housing is formed by two interconnected housing parts, at least the transmission unit being arranged in a first housing part and at least the spindle drive unit being arranged in a second housing part.

### FIELD

The present invention relates to an electromechanical brake for a motor vehicle. Furthermore, the present invention relates to a motor vehicle having such an electromechanical brake.

### BACKGROUND INFORMATION

A service brake is usually a brake that uses brake fluid to press a brake piston together with a brake pad onto a brake disc in order to brake the vehicle. In contrast, a parking brake is designed as an electromechanical brake. As part of the increasing electrification of motor vehicle components, the service brake is also intended to be designed as an electromechanical brake, so that brake fluid and the associated complex valve and line structure can be dispensed with. Such an electromechanical brake could also significantly reduce maintenance requirements.

European Patent No. EP 1 030 979 B1 describes an electromechanical braking apparatus for braking a motor vehicle wheel. The braking apparatus has a brake caliper, in which an electric motor is arranged. The electric motor drives a spindle drive unit, via which brake pads arranged on a brake clamp of the brake caliper can be applied to a brake disc for braking.

European Patent No. EP 0 944 781 B1 describes a brake which can be electromechanically actuated and which presses a brake pad against a brake disc for braking. The brake comprises a spindle drive unit which has a spindle and a spindle nut, the spindle being connected to the brake pad. The spindle nut is fixedly connected to a sleeve which surrounds the spindle nut on the outside. The sleeve is arranged rotatably in the brake caliper via bearings. Permanent magnets are arranged in the sleeve so that they form a rotor of an electric motor. The sleeve is surrounded by a stator, via which the rotor can be driven. By rotating the spindle nut accordingly, the brake pad can be moved axially in order to apply a braking force.

A problem addressed by the present invention is that of providing an electromechanical brake for a motor vehicle that is more economical to produce and has a low weight.

The problem may be solved by an electromechanical brake having certain features of the present invention. Preferred embodiments of the present invention are disclosed herein.

### SUMMARY

The present invention provides an electromechanical brake for a motor vehicle. According to an example embodiment of the present invention, the electromechanical brake comprises an electric motor which drives a spindle drive unit via a transmission unit, via which spindle drive unit a brake actuator is axially movable for braking. A drive housing which accommodates at least the transmission unit and the spindle drive unit is provided. The drive housing is provided as a separate part to a brake clamp encompassing a brake disc and is connected to said brake clamp. The drive housing is formed by two interconnected housing parts, at least the transmission unit being arranged in a first housing part and at least the spindle drive unit being arranged in a second housing part.

A brake actuator is understood to be a part of the electromechanical brake that acts on a brake pad, or is a part of the brake pad, in order to apply a braking force to the brake disc. The brake clamp is understood to be the part of the electromechanical brake that encompasses the brake disc in a pincer-like manner. According to an example embodiment of the present invention, the drive housing and the brake clamp are provided as separate parts which can be connected to one another. The brake clamp and the drive housing can therefore be made of different materials. The brake clamp is usually made of a heavy cast material in order to be able to absorb the high braking forces. The brake clamp is manufactured by means of a casting process. By separating the brake clamp and the drive housing, the drive housing can be manufactured from a lighter material and formation of the brake clamp in the course of the casting process is simplified. The drive housing can therefore also be formed using a more economical production process in comparison with the casting process.

According to an example embodiment of the present invention, the drive housing is additionally divided into two separate housing parts. The two separate parts of the drive housing can in this case be designed according to their loads. The housing part that has the spindle drive unit usually absorbs the braking force, so this housing part must have a greater strength. In contrast, the first housing part is designed to accommodate the transmission unit. The first housing part therefore is not subjected to any braking force. This first housing part can therefore be significantly thinner than the second housing part, so that the weight of the electromechanical brake can be reduced. Likewise, less material is required to form the electromechanical brake, so that the electromechanical brake can also be manufactured more economically. The separate design of the drive housing also has the advantage that each housing part can be produced more easily.

In a preferred example embodiment of the present invention, the first and the second housing part are made of a different material. In particular, the second housing part is made of a stronger material than the first housing part. For the first housing part, a lighter and also more cost-effective material can be used in accordance with the lower load. A weight of the electromechanical brake can therefore be reduced even further, which increases the driving comfort of the electromechanical brake arranged on the unsprung vehicle wheel.

In a further preferred example embodiment of the present invention, the first housing part is formed by a deep-drawing process, a punching process and/or a bending process. Such a manufacturing process has the advantage that it can be carried out cost-effectively. Machining steps can also be partially or completely omitted. The first housing part can therefore be manufactured economically in mass production.

According to an example embodiment of the present invention, preferably, the first housing part is connected to the second housing part by shrinking, pressing, welding, bonding and/or brazing. Using such a connection, the two housing parts can be connected to one another quickly, easily and cost-effectively. In particular, no further fastening means are required to fasten the first housing part to the second housing part. Such a connection of the two housing parts additionally has the advantage that dimensional tolerances can be compensated for by moving the two housing parts relative to one another. The electromechanical brake can therefore be produced more precisely.

In an advantageous development of the present invention, the second housing part is rotationally symmetrical, with the exception of anti-rotation slots for the spindle drive unit. Formation of a rotationally symmetrical component enables economical production of this component, so that a low machining volume is necessary. The second housing part can therefore also be produced more quickly.

According to an example embodiment of the present invention, advantageously, the first housing part forms connecting surfaces for an electric motor and a control device. The electric motor and the control device can therefore be attached directly to the first housing part. Therefore, no additional parts are required to fasten the control device and the electric motor to the first housing part. Fastening of the control device and the electric motor is therefore simplified.

In a further advantageous example embodiment of the present invention, the first housing part is formed in at least two parts, the parts being arranged relative to one another in a radial direction of the drive housing. A radial direction is understood to be a direction which is radial to an extension direction of the drive housing. In other words, the two housing parts are not arranged one behind the other in the axial direction, but rather they abut one another. The two housing parts are therefore connected to the second housing part. An at least two-part design of the first housing part has the advantage over a one-part design that each housing part can be deep-drawn in a radial direction. Therefore, further elements formed in the radial direction can be formed that cannot be formed in an axial deep-drawing direction. Production of the first housing part is made easier as a result, and the further elements do not have to be subsequently attached to the housing, for example by welding.

According to an expedient embodiment of the present invention, the two parts of the first housing part are connected to one another by welding, bonding and/or brazing. By connecting the two parts of the first housing part in this way, fastening means, such as screws, can be dispensed with. In addition, connecting the two parts is made simpler.

According to a further expedient embodiment of the present invention, one of the two parts of the two-part first housing part forms a bearing receptacle for the transmission unit. A bearing for a drive shaft of the transmission unit can be arranged in such a bearing receptacle. Therefore, the drive shaft is better supported in the first housing part. By forming this bearing receptacle using the first housing part, subsequent fastening of such a bearing receptacle can be dispensed with. The first housing part is therefore more economical to produce.

According to an example embodiment of the present invention, preferably, each part of the two-part first housing part is deep-drawn in the radial direction. The radial direction is in this case defined by the extension direction of the drive housing or a rotation axis of the spindle drive unit. A deep-drawing tool therefore deep-draws the parts of the first housing part radially to this rotation axis or extension direction, with respect to an installation position of each part. Accordingly, elements aligned in the radial direction can therefore be formed on the parts of the first housing part. An improved first housing part can therefore be formed.

The present invention additionally provides a motor vehicle having such an electromechanical brake according to the present invention. Such a motor vehicle has the above-described advantages and properties.

Exemplary embodiments of the present invention are illustrated in the figures and explained in more detail in the following description.

### BRIEF DESCRIPTION OF THE DRAWINGS

FIG. 1 is a sectional view of an electromechanical brake according to an exemplary embodiment of the present invention.

FIG. 2 is a sectional view of the first and the second housing part of the drive housing according to an exemplary embodiment of the present invention.

FIG. 3 is a perspective view of the first housing part according to an exemplary embodiment of the present invention.

FIG. 4 is a plan view of the first housing part according to a further exemplary embodiment of the present invention.

FIG. 5 is a perspective view of a first part of the first housing part, according to an example embodiment of the present invention.

FIG. 6 is a perspective view of the second part of the first housing part, according to an example embodiment of the present invention.

### DETAILED DESCRIPTION OF EXAMPLE EMBODIMENTS

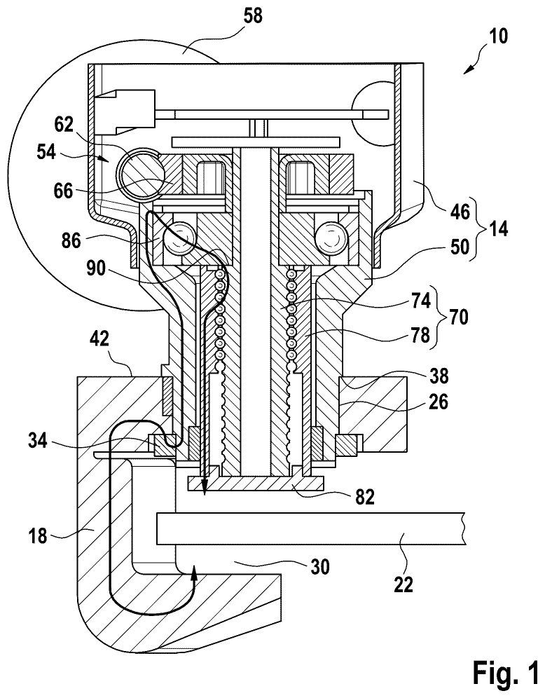

FIG. 1 is a sectional view of an electromechanical brake 10 according to an exemplary embodiment of the present invention.

The electromechanical brake 10 comprises a drive housing 14 which is connected to a brake clamp 18. The brake clamp 18 encompasses a brake disc 22. The drive housing 14 projects through a brake clamp opening 26 and is fastened to the brake clamp 18 in the region of an interior 30 of the brake clamp 18 via a screw connection 34. The drive housing 14 forms a shoulder 38 which abuts an outer face 42 of the brake clamp 18.

The drive housing 14 is formed from a first housing part 46 and a second housing part 50 which are connected to one another and arranged axially with respect to one another. The second housing part 50 is connected to the brake clamp 18. A transmission unit 54 which is formed from a worm 62 driven by an electric motor 58 and from a worm wheel 66 is arranged in the first housing part 46. A spindle drive unit 70, which is designed as a ball screw drive in the exemplary embodiment shown, is arranged in the second housing part 50.

The spindle drive unit 70 comprises a spindle 74 which extends into the first housing part 46, so that the worm wheel 66 can be fastened to an end of the spindle 74. Accordingly, the spindle drive unit 70 is driven via the worm wheel 66. The spindle drive unit 70 additionally comprises a spindle nut 78, at the axial end of which a brake actuator 82 is arranged, which is axially movable together with the spindle nut 78. The brake actuator 82 can therefore be moved in the direction of the brake disc 22. To absorb an axial force, an angular contact ball bearing 86 which interacts with a spindle shoulder 90 is arranged in the second housing part 50.

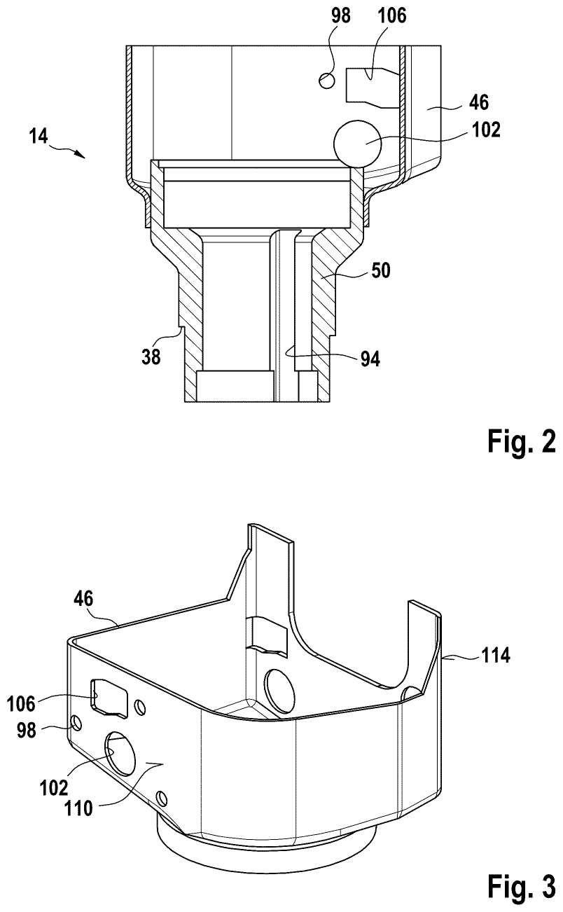

FIG. 2 is a sectional view of the first and the second housing part 46, 50 of the drive housing 14 according to an exemplary embodiment of the present invention. The figure shows that axially aligned anti-rotation slots 94 are formed in the second housing part 50 in order to block the rotation of the spindle nut 78. In addition, it can be seen that the second housing part 50 is rotationally symmetrical, with the exception of these anti-rotation slots 94. Manufacture of the second housing part 50 is therefore simplified. The first housing part 46 has a fastening opening 98, via which the electric motor 58 can be fastened. In addition, a shaft opening 102 is formed in the first housing part 46, through which opening a drive shaft of the worm 62, coming from the electric motor 58, projects. A contact opening 106 is also provided, via which motor contacts can be introduced into the electric motor 58.

FIG. 3 is a perspective view of the first housing part 46 according to an exemplary embodiment of the present invention. The various openings 98, 102, 106 in the first housing part 46 are also shown in this figure. The first housing part 46 additionally forms a connecting surface 110 for the electric motor 58 and a connecting surface 114 for a control device. Therefore, no additional parts need to be provided in order to fasten the electric motor 58 and the control device to the first housing part 46.

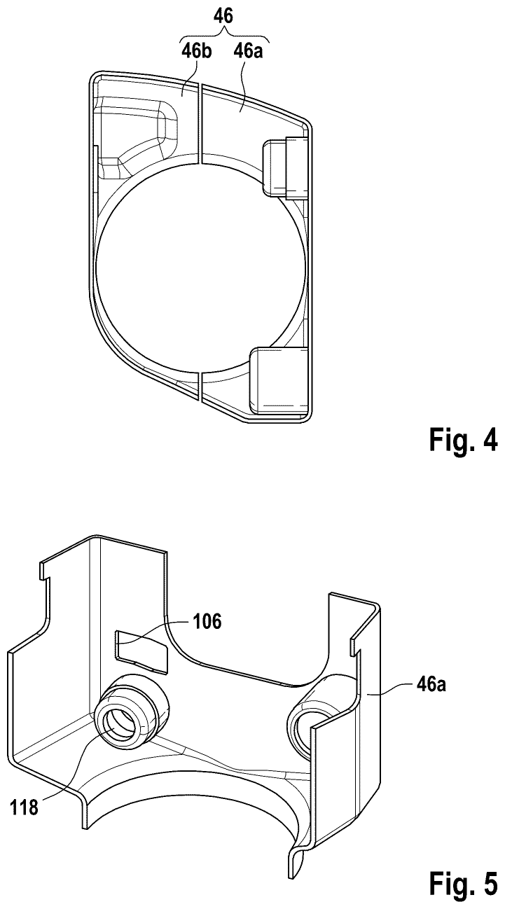

FIG. 4 is a plan view of the first housing part 46 according to a further exemplary embodiment of the present invention. This exemplary embodiment differs from the exemplary embodiment in the above-described figures in that the first housing part 46 is not formed from one part, but rather from two parts 46a, 46b. In an extension direction of the drive housing 14, the two parts 46a, 46b of the first housing part 46 radially abut one another. Each part 46a, 46b therefore also abuts the second housing part 50. By forming the first housing part 46 in this way, the entire first housing part 46 does not have to be produced together. Rather, each part 46a, 46b of the first housing part 46 is formed individually. In contrast to the above-described exemplary embodiment, in which the first housing part 46 is formed in the axial direction by a deep-drawing process, each part 46a, 46b of the first housing part 46 can be formed in the radial direction by a deep-drawing process.

FIG. 5 is a perspective view of a first part 46a of the first housing part 46. This part 46a, like the first housing part 46 from the above-described exemplary embodiment, also forms a contact opening 106. The first part 46a forms, in particular, a bearing receptacle 118 for the drive shaft of the worm 62. Therefore, a bearing is arranged in the bearing receptacle 118, via which an end of the drive shaft is supported. Such elements can be formed by the deep-drawing step in the radial direction. An additional work step for attaching such a bearing receptacle 118 can be dispensed with, in comparison with the exemplary embodiment in FIG. 1-3.

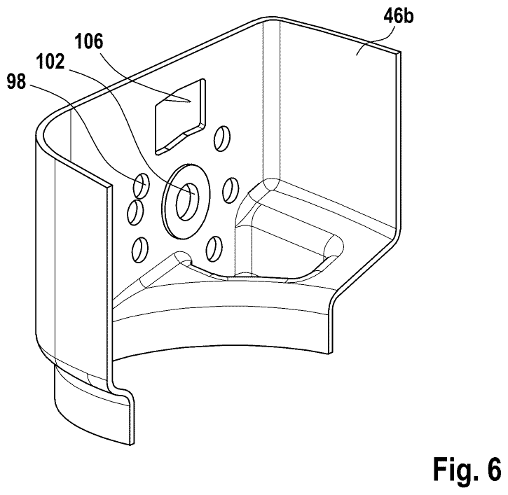

FIG. 6 is a perspective view of the second part 46b of the first housing part 46. This part 46b can also be manufactured by a radial deep-drawing step. The second part 46b, as already described in FIG. 2 and FIG. 3, forms fastening openings 98, a shaft opening 102, and a contact opening 106.

1-11. (canceled)

12. An electromechanical brake for a motor vehicle, comprising:
an electric motor which drives a spindle drive unit via a transmission unit, wherein via the spindle drive unit, a brake actuator is axially movable for braking; and
a drive housing which accommodates at least the transmission unit and the spindle drive unit;
wherein the drive housing is provided as a separate part to a brake clamp encompassing a brake disc and is connected to the brake clamp, the drive housing being formed by two interconnected housing parts, at least the transmission unit being arranged in a first housing part and at least the spindle drive unit being arranged in a second housing part.

13. The electromechanical brake according to claim 12, wherein the first housing part and the second housing part are made of a different material.

14. The electromechanical brake according to claim 12, wherein the first housing part is formed by a deep-drawing process and/or a punching process and/or a bending process.

15. The electromechanical brake according to claim 12, wherein the first housing part is connected to the second housing part by shrinking and/or pressing and/or welding and/or bonding and/or brazing.

16. The electromechanical brake according to claim 12, wherein the second housing part is rotationally symmetrical, except for anti-rotation slots for the spindle drive unit.

17. The electromechanical brake according to claim 12, wherein the first housing part forms connecting surfaces for an electric motor and a control device.

18. The electromechanical brake according to claim 12, wherein the first housing part is formed in at least two parts, the at least two parts being arranged relative to one another in a radial direction of the drive housing.

19. The electromechanical brake according to claim 18, wherein the at least two parts of the first housing part are connected to one another by welding and/or bonding and/or brazing.

20. The electromechanical brake according to claim 18, wherein one of the at least two parts of the first housing part forms a bearing receptacle for the transmission unit.

21. The electromechanical brake according to claim 18, wherein each part of the at least two parts of the first housing part is deep-drawn in a radial direction.

22. A motor vehicle, comprising:
an electromechanical brake including:
an electric motor which drives a spindle drive unit via a transmission unit, wherein via the spindle drive unit, a brake actuator is axially movable for braking, and
a drive housing which accommodates at least the transmission unit and the spindle drive unit,
wherein the drive housing is provided as a separate part to a brake clamp encompassing a brake disc and is connected to the brake clamp, the drive housing being formed by two interconnected housing parts, at least the transmission unit being arranged in a first housing part and at least the spindle drive unit being arranged in a second housing part.
